(19) United States
(12) Patent Application Publication
(10) Pub. No.: US 2025/0045557 A1
(43) Pub. Date: Feb. 6, 2025

(54) SMART, CUSTOMER CENTRIC, PERSONALIZED DIGITAL HUMAN FRAMEWORK

(71) Applicant: Dell Products L.P., Round Rock, TX (US)

(72) Inventors: Divya Maddi, Round Rock, TX (US); Bijan Kumar Mohanty, Austin, TX (US); Hung Dinh, Austin, TX (US)

(21) Appl. No.: 18/365,499

(22) Filed: Aug. 4, 2023

(51) Int. Cl. G06N 3/004; G06Q 30/015; G06Q 30/0204

(52) U.S. Cl. CPC G06N 3/004; G06Q 30/015; G06Q 30/0205

(57) ABSTRACT

One example method includes pre-processing a dataset, the dataset including data and/or metadata indicating attributes of a user, and the dataset also includes data and/or metadata that was generated as a result of an interaction between the user and a computing system, after the dataset is pre-processed, providing the dataset as an input to a machine learning model, using the machine learning model to generate, based on the input, respective target variable value predictions for each target in a group of targets, and each of the targets corresponds to a respective attribute of the user, using the target value variable predictions to create, or modify, a digital human that has attributes corresponding to the attributes of the user, and deploying the digital human so that the digital human is available to interact with the user.

### FIELD OF THE INVENTION

Embodiments of the present invention generally relate to digital entities that are able to interact with humans. More particularly, at least some embodiments of the invention relate to systems, hardware, software, computer-readable media, and methods, for the creation and use of a digital human having various specified human characteristics.

### BACKGROUND

With the popularity of digital humans in enterprises, it has become apparent that the “one size fits all” approach to digital human is problematic. While most enterprises have a global customer base, the preferences of their customers in terms of engaging with a digital human can vary dramatically. For example, customer, or user, preferences may vary in terms of the race, age, and gender of a digital human, as well as other attributes of the digital human such language, accent, and emotion of engagement. In more detail, while many digital human platforms provide APIs (application program interface) to customize the language, accent and emotions, such digital human platforms do not include insightful intelligence to study customer preferences, and predict the attributes that would be preferred by customers or other users. The following examples are illustrative.

Digital humans are quite popular now and many enterprises are working to develop digital humans that can best represent the company value and products. However, these efforts typically lack a comprehensive understanding or consideration of attributes of their global customer base, such as in terms of culture, language, and customs. That is, typical digital humans reflect a “one size fits all” approach by the enterprises and do not consider the preferences of their customers, who may have a variety of different backgrounds. Moreover, while enterprises often collect a significant amount of customer information, this information is typically used primarily for marketing purposes. Thus, there is a lack of insights in understanding the customers culturally, and from other perspectives. Finally, current approaches to the personalization of digital humans lack knowledge and awareness as to what personality a prospective customer might prefer.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a system architecture, and related methods, according to one example embodiment.

FIG. 2 discloses aspects of a metadata repository according to one example embodiment.

FIG. 3 discloses aspects of an intelligent digital human preference prediction engine, and related methods, according to one example embodiment.

FIG. 4 discloses aspects of an architecture of a multi-output neural network for user digital human preference prediction, and related methods, according to one example embodiment.

FIG. 5 discloses example code for reading a datafile into a dataframe.

FIG. 6 discloses example code for encoding categorical values as numerical values.

FIG. 7 discloses example code for splitting a dataset.

FIG. 8 discloses example code for creating a dense neural network model for multi-output classifications.

FIG. 9 discloses example code for compiling and training a model.

FIG. 10 discloses example code for predicting target values.

FIG. 11 discloses an example method according to one embodiment.

FIG. 12 discloses an example computing entity configured and operable to perform any of the disclosed methods, processes, and operations.

### DETAILED DESCRIPTION OF SOME EXAMPLE EMBODIMENTS

Embodiments of the present invention generally relate to digital entities that are able to interact with humans. More particularly, at least some embodiments of the invention relate to systems, hardware, software, computer-readable media, and methods, for the creation and use of a digital human having various specified human characteristics.

One example embodiment of the invention comprises a framework that is intelligent and able to deduce, or infer, a customer preferences and attributes both from information gathered during real time interaction with the user, as well as from a historical interaction with that user, and/or other users. This framework may employ ML (machine learning) to perform the inferencing. By utilizing preferences and attributes such as these to dynamically generate a digital human, an embodiment of the invention may implement a user preference based, personalized digital human with the characteristics and personality important to the user.

In an embodiment, these functions may be achieved by leveraging a DNN (deep neural network) based multi-target classification model and training the DNN using user preferences, as well as historical interaction information, to predict the digital human, language, accent, and other attributes that can be used to dynamically generate a personalized digital human that correlates with the user preferences and user historical information.

Initially, an anonymous user or first-time user, who may also be anonymous, may be presented with a brief set of questions to collect the preferences of that user in terms of digital human, language, and accent, for example, which may be used to generate the digital human. This interaction data, along with any existing information relating to the user, such as regional location, customer type-consumer/commercial, gender, language, and purchase history-type of products, for example, may then be used to recommend/predict the digital human preference attributes of future users. These predicted attributes may then implemented in a personalized digital human with characteristics and personality important to a user, and/or a prospective user.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an advantageous aspect of an embodiment of the invention is that an embodiment may generate a digital entity with attributes corresponding to a specific human user, or group of human users, with whom the digital entity is expected to interact. An embodiment may enable more productive and efficient interactions between users and business, and other, entities. Various other advantages of some example embodiments of the invention will be apparent from this disclosure.

### A. Context for an Example Embodiment of the Invention

With the popularity of digital humans, many enterprises have made the decision to develop their own digital humans for their customers. Digital humans are often the face of the enterprise and the success of them depends not only on the accuracy and speed of the replies they provide, but also on the emotional connectivity between the customers and digital humans. Enterprises invest a huge amount of effort and money to develop their digital human which can best represent their enterprise. These efforts typically are more focused on the enterprise, their products, and the value that the enterprise wants to propagate to its customers. Typically, little consideration is given to the customer base, in terms of their preferences relating to other considerations such as culture, language, and customs.

Customer service operations have gone through enormous transformations recently. Large and small enterprises use agents for supporting their sales, support, and marketing services. It has become imperative to provide such services across many channels including but not limited to email, phone, web, chat, and social media, to name a few. As technology has evolved, enterprises have begun adopting chat bots that can answer most of the simple use cases and help customers 24×7. This approach has enabled agents to streamline their work so they can solve the more complex cases and leave the simple and routine work to bots. The use of such bots has enabled the provision of consistent and quick service, at least as to simple matters, to customers, irrespective of the hour of day.

Larger firms are now looking for ways to take support and service channels to the next level. Companies have already started creating personalized content, shopping, and support experience for their customers, be it movie recommendations on cloud streaming apps or shopping experiences on online marketplaces.

However, large organizations are often spread across multiple countries and continents, and serve customers and other users who may have varied cultures and backgrounds. This presents a challenges in terms of the local beliefs and the sense of appeal for reach in a particular geographic area. Fast food enterprises illustrate well the notion of cultural adaptation of their menu so that the menu items appeal more to local tastes and culinary traditions. This approach has enabled such enterprises to attain a presence and adoption in many countries across the globe.

Diversity is a business imperative these days. Many large companies are in the process of developing digital humans to service their customers and provide a personalized conversation for sales and support for their customers and other partners and users. Customer reach is an important part of this effort. There is no one size fits all and what may be an appropriate digital human for a US company and its US customers may not appeal, or may hold less appeal, to a customer from Asia. For larger enterprises having a wide geographic presence, it may be important to create digital humans that are relatable to their customers around the world.

Thus, an example embodiment of the invention comprises the creation and use of a customer-centric, personalized digital human experience by leveraging customer information as well as customer preferences, locale details, and other information, to predict a customer centric digital human with all the characteristics that a given type of user most likely will prefer and find relatable. An embodiment may utilize this multi-dimensional data along with historical customer interaction data and metadata and use ML (machine learning) classifiers to predict an appropriate digital human for the specific user, based on the preferences and demographics, for example, of that user. This smart prediction based digital human selection not only select the right digital actor for the customer, but also selects the language, accent, emotions, and various other attributes, so as to provide digital human service that is tailored to a particular user or group of users.

### B. Aspects of an Example Architecture

The following is a discussion of aspects of an example architecture according to one example embodiment of the invention. This discussion is not intended to limit the scope of the invention, or the applicability of the embodiments, in any way.

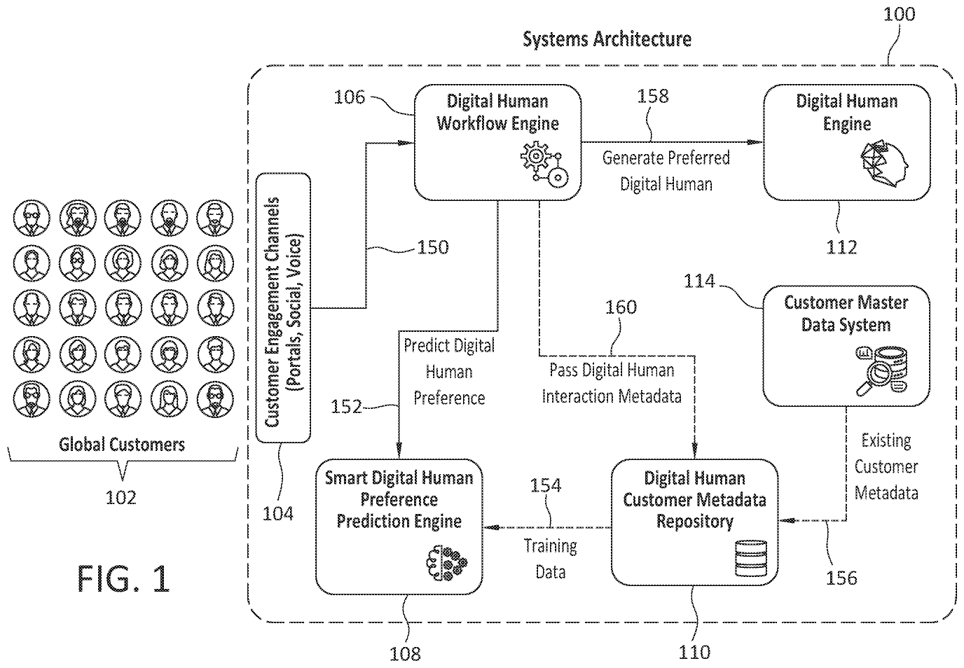

Turning now to FIG. 1, an example architecture is denoted generally at 100. In this example, users 102, possibly distributed globally, may engage with the enterprise systems such as by way of various engagement channels 104 that may include, for example, sales and support portals, social channel, voice, and other avenues. In an embodiment, the engagement channel(s) 104 may serve as a gateway by way of which an enterprise or other entity may collect 150 information, such as user information, so as to enable development and use of a digital human with characteristics that correspond to the preferences of the user, such as a customer for example.

It is noted that while reference is made herein to a ‘customer,’ and ‘customer information,’ the scope of the invention is not limited for use in contexts that involve a customer. More generally, embodiments of the invention are broadly applicable to any circumstances in which a digital human, customized with characteristics corresponding to those of a particular user, group of users, and/or, prospective user(s), may be employed. Following are some non-limiting examples of applications for one or more embodiments. One embodiment of the invention may be employed in a commercial context in which a user interacts with a digital human to obtain assistance with a purchase of a product or service provided by a vendor with which the digital human is associated. As another example, an embodiment of the invention may be employed in a ‘help desk’ context in which a user contacts an entity for assistance in resolving some type of technical problem. In still another example, an embodiment of the invention may be employed in a context where a user contacts an entity with a question about a product or service offered by the entity. As a final example, an embodiment of the invention may be employed in a context where a user contacts an entity with a request for a recommendation, by the entity, about a product or service offered by the entity.

With continued attention now to FIG. 1, a digital human workflow engine 106 may leverage a smart digital human preference prediction engine (SDHPPE) 108 to predict 152 the digital human preference for the user based on existing user metadata and one or more past interactions between the user and an entity. These historical data may be used to train 154 a sophisticated, multi-target deep neural network-based classifier of a smart digital human preference prediction engine 108 to predict multiple preferences such as a gender based specific digital human, language, accent, and emotion such as empathetic, happy, or upbeat for example, that may be used as user preference for dynamic generation of the personalized digital human for that user.

In more detail, the SDHPPE 108 may be trained using, for example, [1] the existing user metadata, which may be stored 156 in a digital human customer metadata repository 110, in the enterprise, [2] user master data management systems if existing, as well as [3] the past interactions and the preferences used in those interactions. Where there is little or no historical data and preferential data available concerning the user, nor information available from anonymous user interactions, a set of questions may be generated and presented to the user to obtain feedback on the relevant user attributes which may then be used to train the smart digital human preference prediction engine 108 to make future predictions as to the characteristics of a digital human to be created for use by a particular user, or group of users.

Thus, an embodiment of the invention may comprise various components that may be used to create and deploy a digital human. Such components may comprise, for example, [1] the digital human workflow engine (DHWE) 106, [2] the digital human customer metadata repository (DHCMR) 110, and [3] the smart digital human preference prediction engine (SDHPPE) 108. Each of these example components is considered in turn below.

### B.1 Example DHWE

In an embodiment, the DHWE 106 may comprise a workflow component that accepts 150, from a user, some user information as the part of engagement between the user and an entity. Such information may include, for example, user credentials and/or a user preference response concerning various attributes identified by the user, such as in the case of an anonymous interaction between the user and the entity. With this user information, the DHWE 106 may leverage 152 the SDHPPE 108 to get the preferences for that user, and the DHWE 106 may then use these preferences and pass 158 the attributes to a digital human engine 112 to generate the personalized digital human. After the digital human is created and interacts with the user, the digital human may store the interaction, and information about the interaction, in the form of metadata in the user metadata repository. In an embodiment, the DHWE 106 may pass 160 digital human interaction metadata to the DHCMR 110 for storage, and possible use as training data that may be provided 154 to the SDHPPE 108.

### B.2 Example DHCMR

Since the accuracy of ML (machine learning) is dependent on its training data, a DHCMR according to an embodiment may be used to harvest and manage the digital human preference metadata of the user. For example, some of the metadata concerning existing user information may be received 156 by the DHCMR 110 from the existing user information and metadata from a CMDS 114 (user master data system). Thus, the CMDS 114 may store, and transmit, information and metadata such as, but not limited to, user type, user location, user gender, and user language. The metadata regarding the digital human preferences of a user may be obtained, for example, from previous interactions between the user and the entity, and/or from user replies submitted to the entity in response to a short questionnaire that may be provided by the entity to the user at the beginning of an engagement between one or more anonymous users and the entity. In an embodiment, these metadata may be managed for training the SDHPPE 108 for preference prediction.

### B.3 Example Data, Information, and Metadata

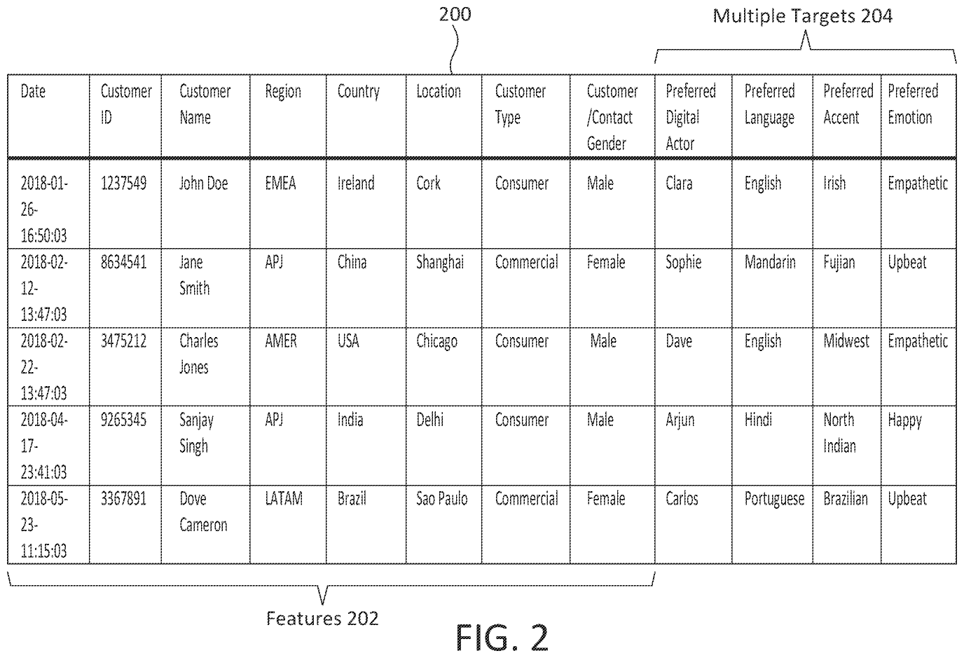

With reference to FIG. 2, a table 200 is disclosed that includes sample training data for a DNN-based multi-output classifier of an SDHPPE, an embodiment of which is discussed below. In this example, the training data includes both features 202 and targets 204. In general, a target 204, such as a user, may comprise one or more features, or attributes, that may be mapped to a new, or existing, digital human for that target. Note that embodiments of the invention are not limited only to the creation of new digital humans, but also extend to the modification of existing digital humans. For example, if a user moves from one country to another, the digital human corresponding to that user may be updated, possibly automatically, with the new location. The location update may, or may not trigger updates to other attributes of the digital human. Note further that the sample of training data in the table 200, with the disclosed features and targets, is provided by way of example, and the scope of the invention is not limited solely to the example features and targets set forth in the table 200.

Once the data, such as the example information in the table 200, is harvested and collected, data engineering and exploratory data analysis may be performed to identify the important features/columns that may influence target variables such as, but not limited to, preferred digital actor, language, accent, and emotion. This process may help to identify unnecessary or irrelevant columns and the features that are highly correlated, and may also help in removing the columns/features to reduce data dimensionality and model complexity, so as to improve the performance and accuracy of the model.

### B.4 Example SDHPPE

Due to the complexity and dimensionality of the data, as discussed above, as well as the nature of multi-target predictions at the same time, an embodiment may employ a DNN and build a custom neural network that has four parallel branches. An example architecture 300 according to one embodiment is discussed below, in light of the following general discussion of an SDHPPE.

Among other things, an SDHPPE according to an embodiment, such as the SDHPPE 108 for example, may predict and suggest the type of digital human, as well as other digital human attributes such as the language, accent, and emotion type. In an embodiment, the SDHPPE 108 may use a supervised learning method and leverage a DNN-based multi-output classifier or ‘model,’ which may be an element of the SDHPPE, to train the DNN-based multi-output classifier with [1] the historical information and metadata, as well as [2] the user digital human preference metadata, to predict a digital human and one or more of its attributes such as, for example, language, accent, and emotion. For a new user, the model may operate to predict a digital human, and its attributes, based on similarities to one or more other users and their known preferences. For example, if another user is from the same country as the new user, a location attribute of the digital human for the new user may be the same as the location attribute for the other user who is from the same country.

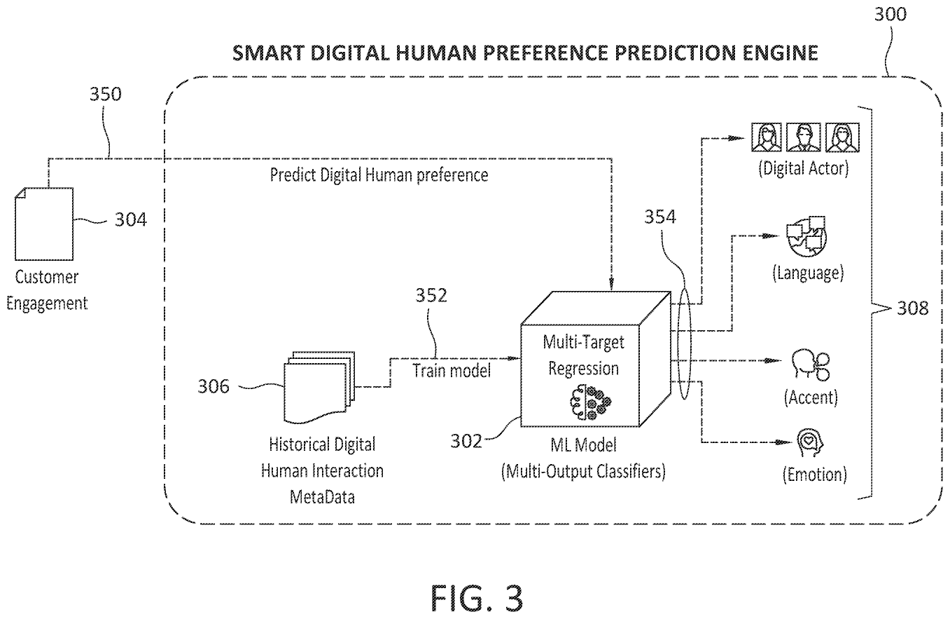

With attention now to FIG. 3, details are provided concerning aspects of an example SDHPPE, which is denoted at 300. The example SDHPPE 300 comprises a model 302 that implements a multi-output neural network (NN), particularly, a DNN that has four parallel branches 304 of network for four types of outputs. In general, and as shown in FIG. 3, various types of inputs may be provided to the model 302. One such input is user engagement information 304, examples of which are disclosed elsewhere herein. The user engagement information 304 may be used by the model 302 to predict a preference of the user for a particular type of digital human.

Another example of an input that may be provided 350 to the model 302 is historical digital human interaction metadata, or ‘historical metadata,’ 306. Examples of historical metadata 306 and other historical information are disclosed elsewhere herein. As shown in FIG. 3, the historical metadata 306 may be used to train 352 the model 302.

In an embodiment, the model 302 may comprise multi-target classification functionality, implemented by multi-target classifiers, that uses training data, and possibly other data, to predict 354 multiple targets 308 that comprise, or define, respective attributes of a digital human for a particular user. Examples of such targets 308 are disclosed at 204 in the table 200.

### B.5 Example Multi-Output NN

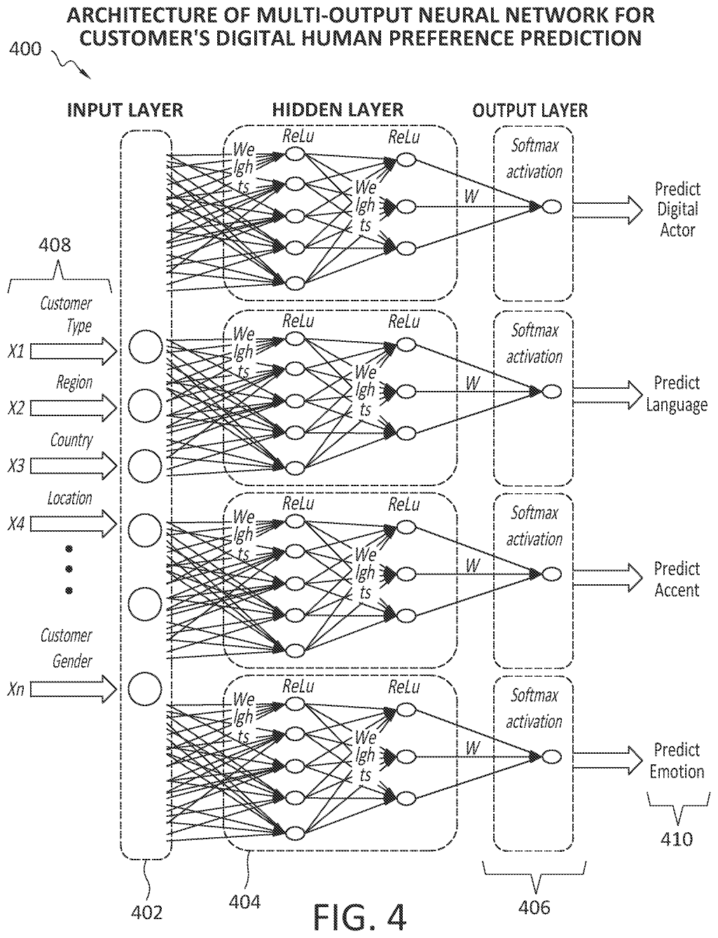

Turning now to FIG. 4, details are provided concerning an architecture for a multi-output NN, an example of which is denoted at 400. As shown, by taking the same set of input variables as a single input layer 402 and building a dense, multi-layer neural network, the model 302 operates as a classifier for multi-output predictions. The multi-output NN 400 may thus comprise the input layer 402, one or more hidden layers 404, and an output layer 406. In an embodiment, the multi-output NN 400 creates four separate branches of network, that is, the combination of the hidden layers 404 and the output layer 406, that connect to the same input layer 402. In an embodiment, the input layer 402 comprises a number of neurons that matches the number of input/independent variables. In an embodiment, the hidden layer 404 comprises two layers, and the neuron on each of those two layers depends upon the number of neurons in the input layer 402. No particular number of input layers 402, hidden layers 404, or output layers 406, is required in any embodiment however.

A respective output layer 406 may be provided for each branch and may comprise various numbers of neurons, based on the type of output to be generated. In one example embodiment, all four branches will use just one neuron in each branch, and a softmax activation function as these are multi-class classifiers, that is, the output values may be one of more than two types of classes. The neurons in the hidden layers 404 may use ReLu activation for all four of the branches.

Note that in general, a softmax function operates to convert a vector of K real numbers into a probability distribution of K possible outcomes. The softmax function may be used as the last activation function of the multi-output NN 400 to normalize the output of the multi-output NN 400 to a probability distribution over predicted output classes. In the example of FIG. 4, four output classes are predicted, namely, ‘digital actor,’ ‘language,’ ‘accent,’ and ‘emotion.’

With continued reference to FIG. 4, the single input layer 402 may receive various types of inputs 408. Example inputs 408 may include, but are not limited to, customer or user type, region, country, location, and customer or user gender. The input layer 402 may direct the various inputs to the hidden layer(s) 404 for processing. The various outputs of the hidden layer(s) 404 may be provided to the output layer(s) 406. In an embodiment, and as noted above, the output layer 406 may generate various predicted classes 410 for respective attributes of a digital human corresponding to the inputs 408.

### C. Example Methods and Operations

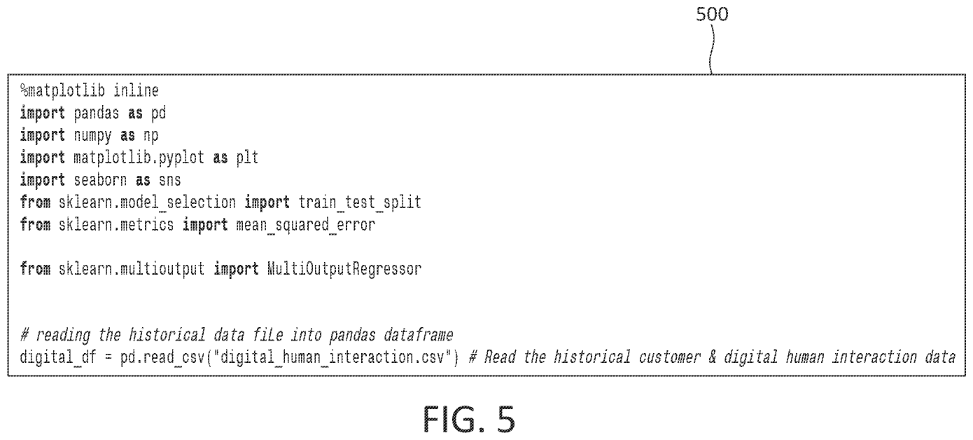

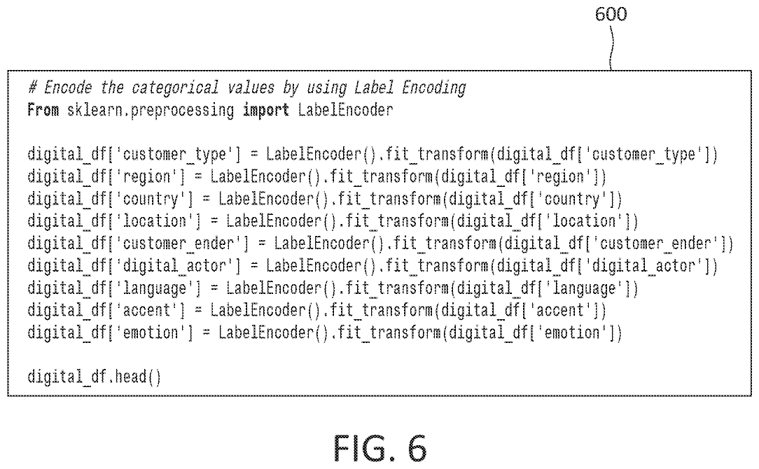

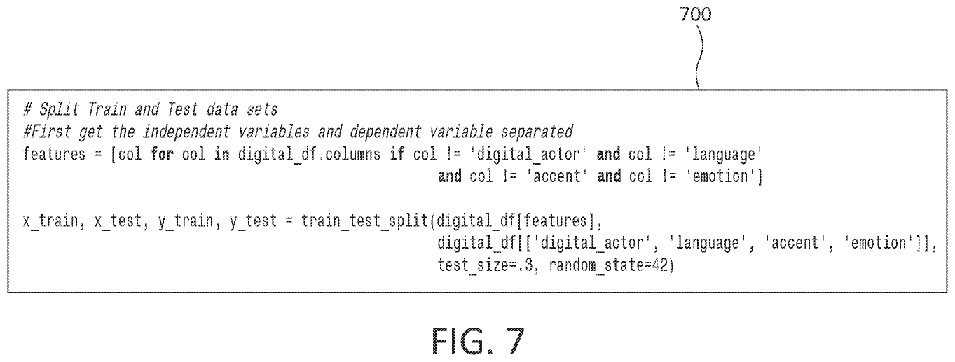

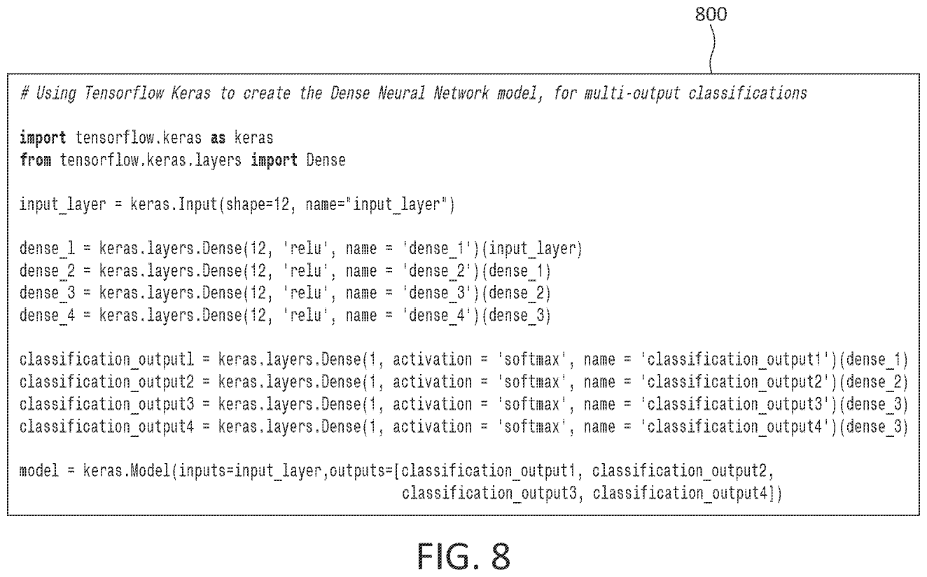

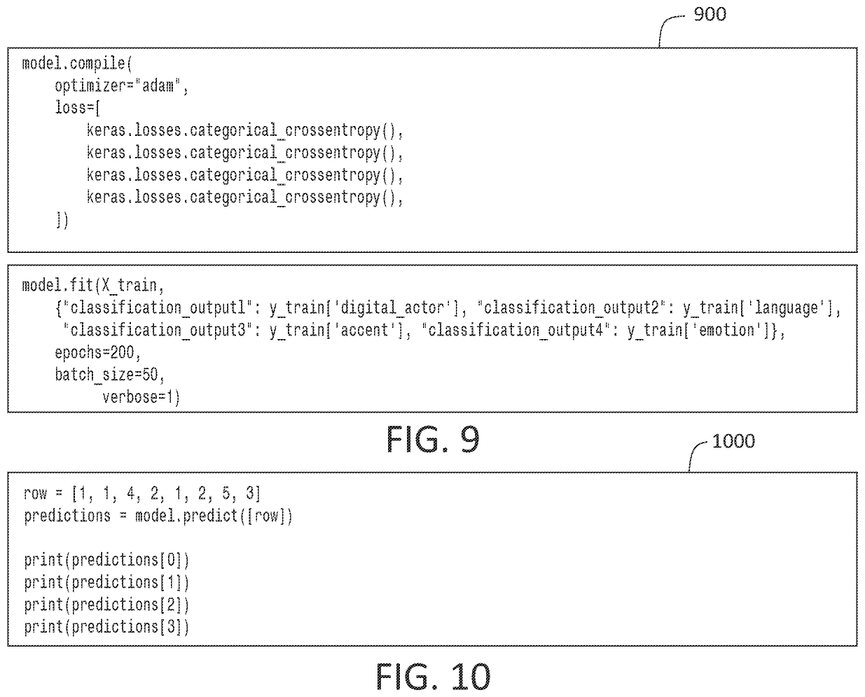

With reference now to FIG. 5, FIG. 6, FIG. 7, FIG. 8, and FIG. 9, details are provided concerning example methods and operations of an embodiment of the invention. In an embodiment, implementation of an SDHPPE, as exemplified in FIGS. 1 through 4, may be performed by using Keras with Tensorflow backend, Python language, Pandas, Numpy and ScikitLearn libraries. These are presented by way of example and are not intended to limit the scope of the invention.

### C.1 Data Pre-Processing

Initially, a dataset of the of the historical digital human interaction metadata file is read and a Pandas data frame may be generated. This data frame may contain all the columns (see the example of table 200) including independent variables, as well as the dependent/target variable columns which, in one embodiment, comprise ‘digital actor,’ ‘language,’ ‘accent,’ and ‘emotion.’ The initial operation may be to conduct pre-processing of data to handle any null or missing values in the columns. Null/missing values in numerical columns may be replaced by the median value of the other values of that column. After performing initial data analysis by creating some univariate and bivariate plots of these columns, the importance and influence of each column may be understood. In an embodiment, columns that have no role or influence on the actual prediction, that is, the target variable(s), may be dropped. FIG. 5 discloses example code 500 that is executable to implement data pre-processing such as that just described.

Note that since ML models according to one embodiment are configured to deal with numerical values, textual categorical values in the columns must be encoded during the data pre-processing. For example, categorical values like customer type, region, country, Location, and gender, as well as the target variables, must be encoded as numerical values. In an embodiment, this encoding may be performed, for example, using LabelEncoder from ScikitLearn library, which is denoted at 600 in FIG. 6.

In an embodiment, the dataset of the of the historical digital human interaction metadata may be split into training and testing datasets using a train_test_split function of ScikitLearn library with 70% (training data)/30% (testing data) split. Since one example use case for an embodiment involves multi-target prediction, it may be important to separate the target variables from the dataset which is shown as below. Example code to perform the dataset splitting is denoted at 700 in FIG. 7.

### C.2 Neural Network Model Creation

In an embodiment, a multi-layer, multi-output capable dense neural network, which may be embodied as/in an SDHPPE (see model 302 of FIG. 3, for example), may be created using Keras library. In particular, the neural network may be built using the Keras functional model, which may enable separate branches to be created and added to the model. In an embodiment, two separate dense layers are added to the input layer with each network is capable of predicting different targets, examples of which include, but are not limited to, digital actor, language, accent, and emotion. Example code to build a neural network is indicated at 800 in FIG. 8.

### C.3 Neural Network Model Creation

A model according to one example embodiment of the invention uses “adam” as an optimizer and the “categorical_crossentropy” as a loss function for all the classification branches of the output. In this example, the model is trained with the training independent variables data (X_train) and the target variables are passed for each path. Example code for the model compile and training processes is indicated at 900 in FIG. 9.

### C.4 Prediction of Target Values

Once the model is trained, it may then be instructed to predict both target values by passing independent variable values to the predict ( ) of the model. The predicted values may be output and incorporated into the digital human, which may then be deployed to interact with the user(s) for which the digital human was developed. Example code for generating predicted target values is indicated at 1000 in FIG. 10.

### D. Further Discussion

As is apparent from this disclosure, some example embodiments of the invention may possess various useful aspects and advantages. For example, an embodiment may comprise the creation and use of a smart framework to formulate programmatically, and with high degree of accuracy, to predict a specific digital human from a team of digital humans, based on a multi-dimensional preference data about culture, language preference and the historical interactions, and training a ML algorithm. As another example, an embodiment of the invention may comprise a method for implementing a deep neural network-based classifier model that is trained using multi-dimensional features of the customer historical interaction data, as well as preference and culture specific information, to predict a digital human that is most relatable for a particular user, or users.

### E. Example Methods

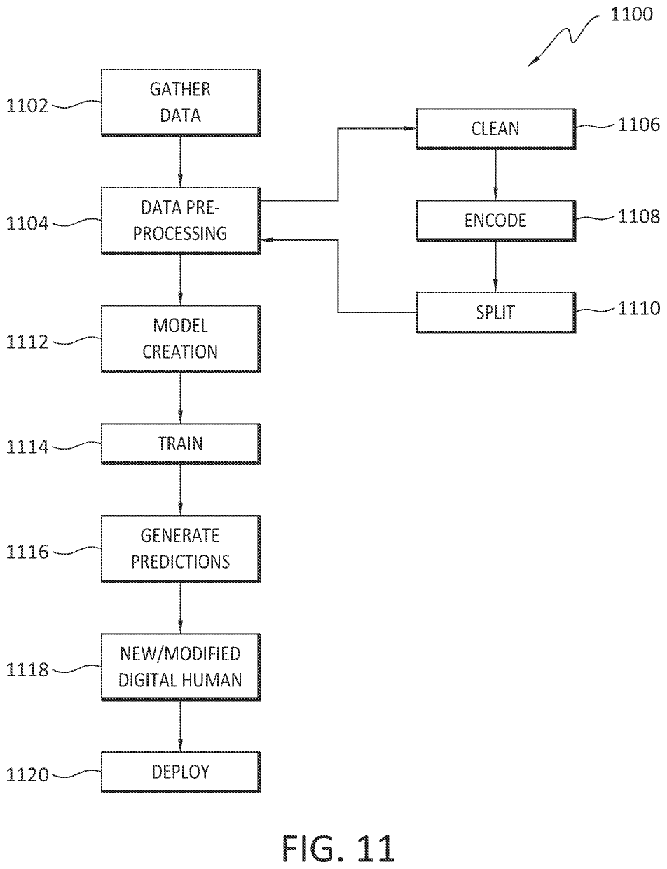

It is noted with respect to the disclosed methods, including the example method of FIG. 11, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 11, an example method according to one embodiment of the invention is indicated at 1100. Initially, various data, metadata, and/or other information, may be gathered 1102. After the data has been gathered 1102, various data pre-processing operations may be performed 1104 on the data before the data is able to be used for training a prediction model. The

Such data pre-processing operations 1104 may comprise, for example, a data cleaning process 1106. In one example embodiment, the data cleaning 1106 may include processing any null, or missing, values in the columns of a dataset. The data cleaning 1106 may also include performing data analysis to determine the respective importance and influence of each of the columns of the dataset. Columns will little or no role or influence may be dropped from the dataset.

Another data pre-processing operation 1104 may be a data encoding process 1108. In general, and as noted elsewhere herein, a data encoding process 1108 may convert textual values in the columns of the dataset, such as textual categorical values, to numerical values that can be understood, and employed, by the model.

A final example of a data pre-processing operation 1104 is a dataset splitting operation 1110. In an embodiment, a dataset splitting operation 1110 may serve to separate target values from the dataset.

After, or before, the data pre-processing 1104 has been performed, a model may be created 1112 that is configured, and operable, to make respective target value predictions for each target in a group of targets. As noted elsewhere herein, each target may correspond to a particular attribute of a digital human that may be created to interact with a particular user, or group of users.

After the model has been created 1112, it may be trained 1114 using the pre-processed data. Once trained 1114, the model is then able to generate target value predictions for one or more targets, or attributes, of a digital human. After the target value predictions have been incorporated 1118 into the digital human, the digital human may then be deployed 1120 for interaction with the user(s) for whom the digital human was created.

### F. Further Example Embodiments

Following are some further example embodiments of the invention. These are presented only by way of example and are not intended to limit the scope of the invention in any way.

Embodiment 1. A method, comprising: pre-processing a dataset, wherein the dataset includes data and/or metadata indicating attributes of a user, and the dataset also includes data and/or metadata that was generated as a result of an interaction between the user and a computing system; after the dataset is pre-processed, providing the dataset as an input to a machine learning model; using the machine learning model to generate, based on the input, respective target variable value predictions for each target variable in a group of target variables, and each of the targets variables corresponds to a respective attribute of the user; using the target value variable predictions to create, or modify, a digital human that has attributes corresponding to the attributes of the user; and deploying the digital human so that the digital human is available to interact with the user.

Embodiment 2. The method as recited in any preceding embodiment, wherein the data and/or metadata including attributes of the user comprises a regional location of the user, user type, gender, and preferred language of the user.

Embodiment 3. The method as recited in any preceding embodiment, wherein the data and/or metadata generated as a result of the interaction comprises data and/or metadata provided anonymously by the user in response to a query transmitted to the user by a computing system.

Embodiment 4. The method as recited in any preceding embodiment, wherein the digital human is operable to interact with the user using one of more of the attributes of the user, and the attributes of the user comprise a language and an accent preferred by the user.

Embodiment 5. The method as recited in any preceding embodiment, wherein the machine learning model comprises a multi-output neural network that includes multiple parallel branches, and each of the branches corresponds to a respective one of the target variables.

Embodiment 6. The method as recited in any preceding embodiment, wherein the target variable value predictions comprise a digital actor, a particular language, a particular accent, and a particular emotion.

Embodiment 7. The method as recited in any preceding embodiment, wherein the model performs a respective softmax activation to obtain each of the predicted target values.

Embodiment 8. The method as recited in any preceding embodiment, wherein the input is received by the model through a single input layer of the model.

Embodiment 9. The method as recited in any preceding embodiment, wherein the pre-processing comprises separating the target variables from other elements of the dataset.

Embodiment 10. The method as recited in any preceding embodiment, wherein the digital human communicates with the user.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

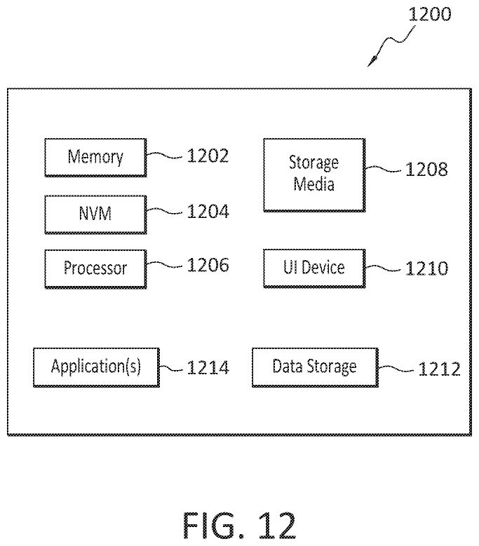

With reference briefly now to FIG. 12, any one or more of the entities disclosed, or implied, by FIGS. 1-11, and/or elsewhere herein, may take the form of, or include, or be implemented on, or hosted by, a physical computing device, one example of which is denoted at 1200. As well, where any of the aforementioned elements comprise or consist of a virtual machine (VM), that VM may constitute a virtualization of any combination of the physical components disclosed in FIG. 12.

In the example of FIG. 12, the physical computing device 1200 includes a memory 1202 which may include one, some, or all, of random access memory (RAM), non-volatile memory (NVM) 1204 such as NVRAM for example, read-only memory (ROM), and persistent memory, one or more hardware processors 1206, non-transitory storage media 1208, UI device 1210, and data storage 1212. One or more of the memory components 1202 of the physical computing device 1200 may take the form of solid state device (SSD) storage. As well, one or more applications 1214 may be provided that comprise instructions executable by one or more hardware processors 1206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
pre-processing a dataset, wherein the dataset includes data and/or metadata indicating attributes of a user, and the dataset also includes data and/or metadata that was generated as a result of an interaction between the user and a computing system;
after the dataset is pre-processed, providing the dataset as an input to a machine learning model;
using the machine learning model to generate, based on the input, respective target variable value predictions for each target variable in a group of target variables, and each of the targets variables corresponds to a respective attribute of the user;
using the target value variable predictions to create, or modify, a digital human that has attributes corresponding to the attributes of the user; and
deploying the digital human so that the digital human is available to interact with the user.

2. The method as recited in claim 1, wherein the data and/or metadata including attributes of the user comprises a regional location of the user, user type, gender, and preferred language of the user.

3. The method as recited in claim 1, wherein the data and/or metadata generated as a result of the interaction comprises data and/or metadata provided anonymously by the user in response to a query transmitted to the user by a computing system.

4. The method as recited in claim 1, wherein the digital human is operable to interact with the user using one of more of the attributes of the user, and the attributes of the user comprise a language and an accent preferred by the user.

5. The method as recited in claim 1, wherein the machine learning model comprises a multi-output neural network that includes multiple parallel branches, and each of the branches corresponds to a respective one of the target variables.

6. The method as recited in claim 1, wherein the target variable value predictions comprise a digital actor, a particular language, a particular accent, and a particular emotion.

7. The method as recited in claim 1, wherein the model performs a respective softmax activation to obtain each of the predicted target values.

8. The method as recited in claim 1, wherein the input is received by the model through a single input layer of the model.

9. The method as recited in claim 1, wherein the pre-processing comprises separating the target variables from other elements of the dataset.

10. The method as recited in claim 1, wherein the digital human communicates with the user.

11. A non-transitory storage medium having stored therein instructions that are executable by one or more hardware processors to perform operations comprising:
pre-processing a dataset, wherein the dataset includes data and/or metadata indicating attributes of a user, and the dataset also includes data and/or metadata that was generated as a result of an interaction between the user and a computing system;
after the dataset is pre-processed, providing the dataset as an input to a machine learning model;
using the machine learning model to generate, based on the input, respective target variable value predictions for each target variable in a group of target variables, and each of the targets variables corresponds to a respective attribute of the user;
using the target value variable predictions to create, or modify, a digital human that has attributes corresponding to the attributes of the user; and
deploying the digital human so that the digital human is available to interact with the user.

12. The non-transitory storage medium as recited in claim 11, wherein the data and/or metadata including attributes of the user comprises a regional location of the user, user type, gender, and preferred language of the user.

13. The non-transitory storage medium as recited in claim 11, wherein the data and/or metadata generated as a result of the interaction comprises data and/or metadata provided anonymously by the user in response to a query transmitted to the user by a computing system.

14. The non-transitory storage medium as recited in claim 11, wherein the digital human is operable to interact with the user using one of more of the attributes of the user, and the attributes of the user comprise a language and an accent preferred by the user.

15. The non-transitory storage medium as recited in claim 11, wherein the machine learning model comprises a multi-output neural network that includes multiple parallel branches, and each of the branches corresponds to a respective one of the target variables.

16. The non-transitory storage medium as recited in claim 11, wherein the target variable value predictions comprise a digital actor, a particular language, a particular accent, and a particular emotion.

17. The non-transitory storage medium as recited in claim 11, wherein the model performs a respective softmax activation to obtain each of the predicted target values.

18. The non-transitory storage medium as recited in claim 11, wherein the input is received by the model through a single input layer of the model.

19. The non-transitory storage medium as recited in claim 11, wherein the pre-processing comprises separating the target variables from other elements of the dataset.

20. The non-transitory storage medium as recited in claim 11, wherein the digital human communicates with the user.
